(19) United States
(12) Patent Application Publication
(10) Pub. No.: US 2026/0220844 A1
(43) Pub. Date: Jul. 30, 2026

(54) BUILDING IMAGE GENERATION TRAINING DATASETS USING VARIABLE CAPTIONING

(71) Applicant: GDM Holding LLC, Mountain View, CA (US)

(72) Inventors: Cristina Nader Vasconcelos, Montreal (CA); Kevin Jordan Swersky, Toronto (CA); David James Fleet, Toronto (CA); Zarana Pareshkumar Parekh, San Jose, CA (US)

(21) Appl. No.: 19/039,704

(22) Filed: Jan. 28, 2025

(51) Int. Cl. G06T 11/60

(52) U.S. Cl. CPC G06T 11/60

(57) ABSTRACT

This specification describes a method performed by one or more data processing apparatus. The method comprises obtaining a plurality of images for captioning. The method further comprises processing, by an image captioning machine learning model and for each image of the plurality of images, a model input comprising the image and an input prompt to generate a caption for the image. The input prompt comprises an indication of a level of specificity for the caption and the generated captions for the plurality of images have mixed levels of specificity.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers to generate an output for a received input. For example, a deep neural network is a deep machine learning model that includes an output layer and one or more hidden layers that each apply a non-linear transformation to a received input to generate an output.

### SUMMARY

According to a first aspect, there is provided a method performed by one or more data processing apparatus. The method comprises obtaining a plurality of images for captioning. The method further comprises processing, by an image captioning machine learning model and for each image of the plurality of images, a model input comprising the image and an input prompt to generate a caption for the image. The input prompt comprises an indication of a level of specificity for the caption and the generated captions for the plurality of images have mixed levels of specificity.

In some implementations, the model input comprises one or more variables. For example, the one or more variables can include the indication of a level of specificity for the caption.

In some implementations, the indication of a level of specificity comprises a category selected from a set of categories defining a hierarchy.

In some implementations, the indication of a level of specificity is based upon one or more captioning dimensions. For example, the one or more captioning dimensions can comprise one or more of the following: caption length, attribute specificity, quantification, location, scale, objectivity, in-image text, and image style.

In some implementations, the method further comprises determining a value for one or more of the captioning dimensions. For example, determining a value for one or more of the captioning dimensions can comprise: obtaining a probability distribution over the range of possible values for each captioning dimension of the one or more captioning dimensions; and selecting a value for each captioning dimension based upon sampling from the corresponding probability distribution.

In some implementations, each captioning dimension is associated with a set of sub-prompts and determining a value for a captioning dimension can comprise selecting a sub-prompt from the associated set of sub-prompts.

In some implementations, the indication of a level of specificity is based upon a combination of the selected sub-prompts.

In some implementations, the method further comprises identifying, by the image captioning machine learning model, the entities depicted in the image and their relationships. The one or more variables can be based upon the identified entities and their relationships.

In some implementations, the one or more variables are further based upon one or more of the following: synonyms for an entity, attributes of an entity, position of an entity, or actions being performed by an entity. The method can further comprise identifying these variables by the image captioning machine learning model.

In some implementations, the indication of a level of specificity comprises an indication of a mixture of a plurality of variables.

In some implementations, where an image of the plurality of images is associated with an existing image caption, the processing to generate a caption for the image can be further based upon the existing image caption, and the generated caption is different to the existing image caption.

In some implementations, the image captioning machine learning model is based upon a generative machine learning model. For example, the image captioning machine learning model can be based upon a multi-modal large language model (LLM) type generative machine learning model (e.g., a foundation type model).

In some implementations, the input prompt comprises an indication of a plurality of levels of specificity; and one or more captions can be generated for each of the levels of specificity of the plurality of levels of specificity.

In some implementations, the method further comprises training an image generation machine learning model using the generated captions.

According to a second aspect, there is provided a method comprising obtaining a plurality of images for captioning. The method further comprises generating, by an image captioning machine learning model, one or more captions for each image of the plurality of images, wherein the generated captions for the plurality of images have mixed levels of specificities. Generating a caption for an image comprises: identifying, by the image captioning machine learning model, one or more entities depicted in the image and one or more properties of the one or more entities; and processing, by the image captioning machine learning model, a model input based upon the image, the identified one or more entities and properties, and an indication of a level of specificity to generate the caption for the image.

According to a third aspect, there is provided a method comprising obtaining a plurality of images for captioning. The method further comprises generating, by an image captioning machine learning model, one or more captions for each image of the plurality of images, wherein the generated captions for the plurality of images have mixed levels of specificities. Generating a caption for an image comprises: determining a value for one or more captioning dimensions; generating an input prompt based upon the determined values to indicate the level of specificity of the caption to be generated; and processing, by the image captioning machine learning model, the image and the input prompt to generate the caption for the image.

In some implementations, each captioning dimension is associated with a set of sub-prompts and determining a value for a captioning dimension comprises selecting a sub-prompt from the associated set of sub-prompts.

According to a fourth aspect, there is provided a system comprising one or more data processing apparatus and a memory. The memory stores instructions that when executed by the one or more data processing apparatus, causes the one or more data processing apparatus to carry out a method according to any of the first, second or third aspects.

According to a fifth aspect, there is provided a non-transitory computer-readable storage medium comprising instructions that when executed by one or more data processing apparatus causes the one or more data processing apparatus to carry out a method according to any of the first, second or third aspects.

It will be appreciated that features described in the context of one aspect may be combined with features of one or more other aspects. For example, the features of first aspect can be combined with the features of second and third aspects.

Particular embodiments of the subject matter described in this specification can be implemented so as to realize one or more of the following advantages.

Data generation systems, e.g., image generation systems, can generate data based upon a user prompt comprising instructions for generating the data. The user prompt typically includes instructions in natural language. In some data generation systems, the user prompt is modified using a generative machine learning model to provide a modified user prompt that better matches the distribution of prompts used to train the data generation system. This prompt re-writing however introduces additional latency into the data generation process.

The techniques described herein enables the building or augmenting of training datasets that can include captions that are better matched to the length of prompts that are typically provided by users. As such, it may be possible to omit the user prompt re-writing/expansion phase from the generation process, thereby reducing latency of the generation process.

The dataset also includes more detailed captions that have different levels of specificity. As such, many different examples of a particular concept can exist at different levels of abstraction in the dataset. A generative model can therefore more easily learn underlying concepts and principles to enable more coherent compositionality in line with the real-world. The techniques described herein also provides for improved diversity in the training dataset which can improve the generalization capability of a generative model.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic block diagram illustrating an example of an image captioning system.

FIG. 2 is a flowchart illustrating an example method for building a training dataset for training an image generation machine learning model.

FIG. 3 is a flowchart illustrating another example method for building a training dataset for training an image generation machine learning model.

FIG. 4 is a flowchart illustrating a further example method for building a training dataset for training an image generation machine learning model.

FIGS. 5A to 5C are example images for captioning.

Like reference numbers and designations in the various drawings indicate like elements.

### DETAILED DESCRIPTION

Generative machine learning models have been used to generate data of many different modalities including text data, image data, video data and audio data. A user can provide a prompt specifying instructions for the data to be generated. For example, a user prompt can specify the objects to be depicted in an image generated by an image generation machine learning model.

Such models are typically trained using large scale web data. For example, image generation models can be trained using pairs of images and “alt text” captions that are normally human generated descriptions of an image. Such data however is typically noisy, the captions can vary in quality and correctness. It has been found that augmenting training datasets with synthetic captions generated by image captioning machine learning models can result in improved performance of image generation models. The generation of synthetic captions is typically unconstrained and the generated captions typically describe the objects/entities depicted in an image with a high degree of detail.

However, when these image generation models are put to use, users typically provide input prompts that are short in length, resulting in a potential mismatch in the distributions between the synthetic captions used for training and the user prompts seen by the model at inference. This can lead to reduced generation performance. In order to address this performance gap, large language models (LLMs) have been used to re-write user prompts to include further details to better match the distribution of synthetic captions seen during training. Such prompt re-writing however introduces additional latency into the generation process. In addition, training on synthetic captions that all have a high-level of detail can potentially hinder the image generation model's ability to generalize and to learn real-world concepts and physical principles as various different concepts are entangled together in one rigid interpretation of an image. This can also lead to biases in the trained model if certain concepts are rarely seen together in the training dataset.

The techniques described herein provide for building (or augmenting) training datasets for training generative machine learning models using variable captioning. That is, synthetic captions can be generated with specificity constraints such that the training dataset comprises synthetic captions having a mixture of captions at different levels of specificity. For example, a low-level of specificity can be a short caption such as “a squirrel in a park” that establishes a general scene and may correspond to the types of prompts that are typically provided by users. A medium-level of specificity can add spatial context without fixing the precise arrangement, e.g., “a squirrel near a tree and a bench in a park”. A high-level of specificity can provide further details for one specific interpretation, e.g., “a red squirrel holding an acorn, sitting on a weather worn, wooden bench under an old oak tree in a park.”

At a basic level, the captioning model can be provided with an input prompt that comprises an indication of the level of specificity for the generated caption, with a mixture of levels of specificity used across the dataset.

In other implementations, the input to the captioning model can be dynamically constructed by determining values for one or more variables. For example, in one implementation, an input prompt and the level of specificity is based upon determining values for a set of captioning dimensions. A captioning dimension can relate to any aspect of a caption, for example, the set of captioning dimensions can include caption length, attribute specificity, quantification, location, scale, objectivity, in-image text and image style. Different captioning dimensions and different values for each captioning dimension can be selected to provide different levels of specificity for each caption. As such, captions can be generated with a greater degree of control over the level of specificity whilst also enhancing diversity through the selection of a wide range of values for the captioning dimensions.

In another implementation, a two-stage process is used for captioning. In a first, knowledge extraction stage, the captioning model identifies the entities and their relationships that are present in a training example. In a second, captioning stage, the captioning model generates captions using the identified entities and relationships from the first stage. The captioning model can be prompted to generate captions of different levels of specificity and including different combinations of the identified entities and relationships to enable the generation of captions of different levels of specificity and diversity for each training example. The model input in the captioning stage is therefore based upon dynamically generated output from the knowledge extraction stage. The input prompt used in the captioning stage can also be generated based upon the selection of captioning dimensions and values to provide further variability.

The techniques described herein therefore enables the building of training datasets that can include captions that are better matched to the length of prompts that are typically provided by users. As such, it may be possible to omit the user prompt re-writing/expansion phase from the generation process, thereby reducing latency of the generation process.

The dataset also includes more detailed captions that have different levels of specificity. As such, many different examples of a particular concept can exist at different levels of abstraction in the dataset. A generative model can therefore more easily learn underlying concepts and principles to enable more coherent compositionality in line with the real-world. The techniques described herein also provides for improved diversity in the training dataset which can improve the generalization capability of a generative model.

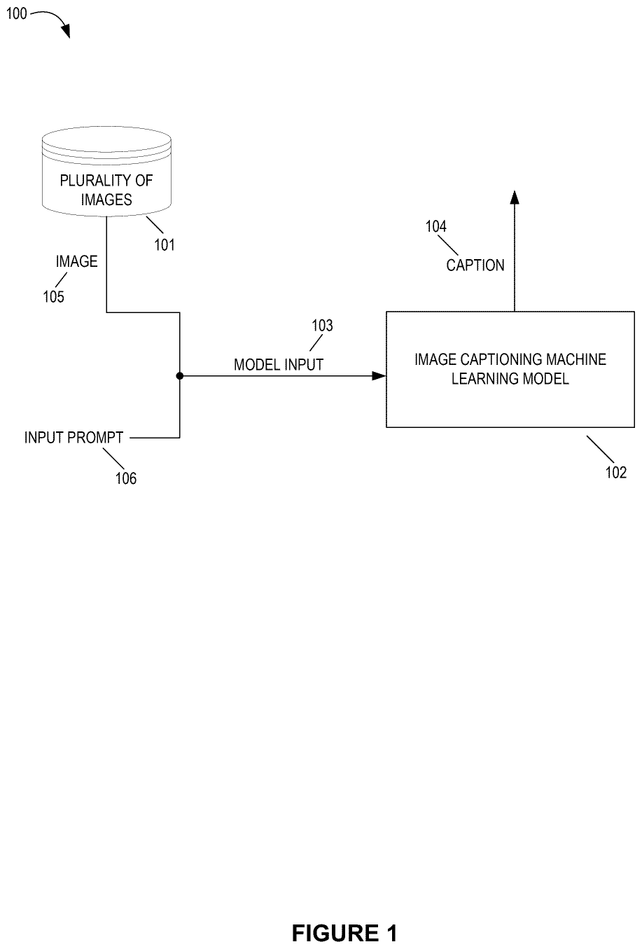

Referring now to FIG. 1, an image captioning system 100 is shown. The image captioning system 100 can be implemented using one or more data processing apparatus in one or more locations. The data processing apparatus can include any appropriate hardware such as a personal computer, a server, a laptop, a mobile device or more specifically any type of processing unit such as a CPU, GPU, TPU or specialized hardware apparatus such as an FPGA or ASIC.

The image captioning system 100 is configured to obtain a plurality of images 101 for captioning. The plurality of images 101 can be part of an existing image dataset comprising pairs of images and captions. In some implementations, the images are obtained from the Internet and the corresponding “alt text” for the image is used as the caption. Such data however is typically noisy, that is, some captions can be incorrect, inaccurate or unsuitable for training an image generation machine learning model. In some implementations, the existing image dataset only includes classification labels rather than natural language captions or the images can have no corresponding labels or captions.

The image captioning system 100 comprises image captioning machine learning model 102. The image captioning machine learning model 102 is configured to process a model input 103 to generate a caption 104 for each image of the plurality of images 101. Any suitably trained image captioning machine learning model 102 can be used. For example, the image captioning machine learning model 102 can be based upon a multi-modal large language model (LLM) that has been trained to provide descriptions of input images when prompted to do so. Generally, a multi-modal LLM can be pre-trained on large scale web data and fine-tuned to respond to prompts and carry out a particular task using a smaller quantity of high-quality data using supervised learning and/or through learning techniques that attempts to drive the model to match user preference rankings of model output such as reinforcement learning with human feedback (RLHF) or direct preference optimization (DPO). Further details regarding training of LLM-based models is described in more detail below.

As shown in FIG. 1, the model input 103 comprises a respective image 105 from the plurality of images 101 and an input prompt 106. The input prompt 106 can be text in natural language that instructs the image captioning machine learning model 102 to generate a caption 104 for the image 105. The input prompt 106 comprises an indication of a level of specificity for the caption 104 and the generated captions for the plurality of images have mixed levels of specificity. In some implementations, the input prompt 106 can specify the generation of multiple captions each having different levels of specificity. Thus, a single image can be associated with multiple captions. Alternatively, only one caption is generated per image but the level of specificity in each input prompt 106 varies across the plurality of images 101.

The input image 105 can comprise raw pixel values or can be an encoding or embedding representing the image 105.

In some implementations, the model input 103 comprises one or more variables. The image captioning system 100 can be configured to dynamically generate the model input 103 by dynamically determining values for the one or more variables at run time. The dynamic construction of the model input 103 and the use of one or more variables can enable a greater range of captions to be generated and provide a greater degree of control over the level of specificity.

In some implementations, the one or more variables includes the indication of the level of specificity for the caption. At a basic level, the indication of the level of specificity can comprise a category selected from a set of categories defining a hierarchy. For example, the set of categories can be “low”, “medium”, and “high” and one category can be selected at random to indicate the level of specificity for the caption. The selection can be carried out by sampling from a uniform probability distribution or as discussed above, it is possible to generate captions at each level of specificity for each image. It will be appreciated that any suitable number of categories can be used to define the levels of specificity.

In order to provide greater control of the captioning process however, the level of specificity can be based upon one or more captioning dimensions. A captioning dimension can control a particular aspect of a caption. For example, the one or more captioning dimensions can include a caption length. The caption length can specify how long the generated caption ought to be. This can be specified in terms of the number of words, e.g., at most 3 words, at most 10 ten words, and/or in terms of the number of paragraphs, e.g., at most one paragraph, at most five paragraphs, for example. A further option that provides for an unconstrained length, e.g., any length, can also be provided.

As another example, the one or more captioning dimensions can include attribute specificity. This dimension can include whether the attributes and nouns used in the captions should be generic or specific, e.g., a dog vs. a specific breed of dog; describe only the main entity in the image or all of the entities depicted in the image; and the use of ordinary or atypical language for describing the attributes of the entities, e.g., common attributes that can apply to many different entities vs attributes that are specific to the entity.

As another example, the one or more captioning dimensions can include quantification. For example, whether to provide an exact count of each object depicted in the image, or whether to provide an inexact quantification, e.g., some, a few, many, lots, or whether to omit mention any quantities.

As another example, the one or more captioning dimensions can include location. For example, whether to include the relative positions of entities and whether to include the location of a scene.

As another example, the one or more captioning dimensions can include scale. For example, whether to include the relative sizes of entities and attributes and whether to relate the sizes to their real-world counterparts.

As another example, the one or more captioning dimensions can include objectivity. That is, whether an entity should be described in terms of factual attributes only or whether subjective aspects can be included, e.g., beauty, emotion.

As another example, the one or more captioning dimensions can include in-image text. For example, if the image contains text, whether the text should be provided in the caption, and whether the attributes of the text should be described, e.g., font, size, position.

As another example, the one or more captioning dimensions can include image style. For example, the artistic style/type of image, and visual characteristics such as composition, color, silhouette and texture amongst others.

Other captioning dimensions can also include, use of negations/negative constructions, use of personas (e.g., writing style), use of other conditioning signals such as distribution of user prompts.

In order to determine the level of specificity, the image captioning system 100 can be configured to determine a value for one or more of the captioning dimensions. For example, a probability distribution over the range of possible values for each captioning dimension can be obtained and a value selected for each captioning dimension based upon sampling from the corresponding probability distribution. The probability distribution can be a uniform probability distribution to enable a balanced selection, or the probability distribution can be any other suitable probability distribution. The range of values for each captioning dimension can be any suitable range as deemed appropriate by a person skilled in the art. The range of values can also include a “null” value, the selection of which would allow that captioning dimension to be omitted from the level of specificity. Alternatively, the image captioning system 100 can be configured to first select which of the captioning dimensions to include before determining the values of the selected captioning dimensions. Like the selection of values, the selection of which captioning dimensions to include can also be based upon sampling from a probability distribution, for example, each captioning dimension can have equal probability of being selected/not selected.

In some implementations, each captioning dimension can be associated with a set of sub-prompts and determining a value for a captioning dimension comprises selecting a sub-prompt from the associated set of sub-prompts. Thus, each value can map to a sub-prompt or the range of values for the captioning dimension can be the set of sub-prompts themselves. For example, for the caption length dimension, the sub-prompts can include, “Keep the output to at most 3 words”, “Keep the output to at most 10 words”, “Keep the output to at most two paragraphs” or any other sub-prompts representing appropriate caption lengths. Thus, when selecting a value for a captioning dimension, one of the sub-prompts from the set of sub-prompts can be selected. The indication of the level of specificity can be based upon a combination of the selected sub-prompts for each captioning dimension. For example, the sub-prompts can be concatenated. The input prompt 106 can comprise the combined sub-prompts (or more generally comprise the selected values for the captioning dimensions). In this way, the indication of the level of specificity/the input prompt 106 can be dynamically constructed. Thus, the one or more variables of the model input 103 discussed above can include the one or more captioning dimensions.

The table below provides further examples of sub-prompts for various captioning dimensions.

| Dimension | Example sub-prompts |
|---|---|
| Caption length | (“Keep the output to at most 3 words.”) |
| | (“Keep the output to at most 5 words.”) |
| | (“Keep the output to at most six paragraphs.”) |
| Attribute | (“Think about visual attributes that uniquely |
| specificity | describe the main entity in the image and include |
| | them in details.”) |
| | (“Incorporate extremely specific attributes in |
| | the description of the most salient entity, that |
| | differentiate the present example from other |
| | examples of the same entity.”) |
| | (“Incorporate Genericities: that is, describe |
| | the single most salient entity using generic nouns |
| | and attributes. For instance: if it is an animal, |
| | refer to it as animal instead of its species or |
| | breed; if a well known dish is presented, just |
| | refer to it as a food. Extend this choice for |
| | generic descriptions into other entities.”) |
| Quantification | (“If there are multiple units of any object, |
| | please specify how many.”) |
| | (“If there are multiple units of any object, |
| | please specify how many spelling out numbers.”) |
| Location | (“Please specify the position of the main |
| | entities that comprise the image are located |
| | relative to each other.”) |
| | (“Please describe the location of the scene.”) |
| Scale | (“You can include attributes that refer to the |
| | entities' relative size. That is, describe a |
| | comparison of the size of one object to another |
| | within the image.”) |
| | (“You can include scale attributes that refer |
| | to the relationship between the size of objects |
| | in the image and their real-world counterparts.”) |
| Objectivity | (“The description must be purely factual, with |
| | no subjective speculation.”) |
| | (“Use attributes to describe the visual |
| | appearance of elements of an image that are factual |
| | and not subjective.”) |
| | (“You may describe emotions associated with |
| | the elements that compose the image.”) |
| | (“Include in your response attributes to describe |
| | the observable aspects of the entities in the image |
| | that are factual and not subjective. Here's a |
| | list of sample attributes to describe the visual |
| | appearance of elements in an image that are factual |
| | and not subjective: |
| | Shape and Form: |
| | Geometric Shapes: Circle, square, triangle, rectangle, |
| | oval, diamond, etc. |
| | . . . |
| | You have the option to select other relevant factual |
| | attributes that are not explicitly mentioned here. |
| | Do not add attributes that lack certainty.”) |
| In-image text | (“Describe any text presented in the image using |
| | double quotes.”) |
| | (“If any text is present in the image, mention |
| | where it is, and the font.”) |
| Image style | (“You should note visual characteristics such |
| | as composition, silhouette, color, and texture |
| | whenever they are unambiguously clear”) |
| | (“Do not forget to mention the type/style of |
| | the image.”) |

In some implementations, a plurality of different input prompts can be constructed. In some implementations, the plurality of input prompts can be combined and provided together to the image captioning machine learning model 102 to generate a plurality of corresponding captions. In other implementations, each input prompt is processed separately by the image captioning machine learning model 102.

The use of captioning dimensions enables greater control over the level of specificity for the caption and can help to ensure a sufficient level of diversity in the generated captions across the plurality of images 101.

In another implementation, the image captioning system 100 can be configured to follow a two-stage process to generate one or more captions for an image 105. In more detail, in the first stage, the image captioning machine learning model 102 can be configured to identify the entities depicted in the image 105 and their relationships. Then in the second stage, the image captioning machine learning model 102 can be configured to generate one or more captions for the image based upon the identified entities and relationships. Thus, the captioning process is split into two sub-tasks. In some cases, splitting a task into smaller sub-tasks can help to improve the performance of the model.

For LLM-based image captioning models, the two-stage process can be implemented using a chain of prompts. The first prompt can instruct the image captioning machine learning model 102 to identify the entities and their relationships. In some implementations, for each entity, the image captioning machine learning model 102 is instructed to also generate synonyms for the entity. In some implementations, the image captioning machine learning model 102 is instructed to also identify attributes, positions/location, and/or actions being performed by the identified entity/entities.

The output of the first stage can then be provided as part of the model input 103 for the second stage. The prompt for the second stage (input prompt 106) can instruct the image captioning machine learning model 102 to generate a caption that includes a mixture of elements from the output of the first stage. For example, that the caption should include the attributes of the entities and the actions being performed, or the caption should include the position of entities and their relationships. More generally, the output of the first stage can be considered to be the one or more variables for the model input 103 discussed above. Thus, the one or more variables can include the identified entities, their relationships, synonyms for an entity, attributes of an entity, position/location of an entity and/or the actions being performed by the entity. The indication of the level of specificity can comprise an indication of a mixture of a plurality of variables, e.g., attributes and actions, or positions and relationships as mentioned, or any other appropriate combination.

In some implementations, the input prompt 106 in the second stage is static, that is, the same input prompt can be used for each image that is to be captioned. For example, the input prompt 106 can instruct the model to generate captions for a plurality of different levels of specificities using the output of the first stage, e.g., to generate captions of low specificity, to generate captions of medium specificity, to generate captions of high specificity, to generate captions that include one or more attributes, to generate captions that include one or more actions, to generate captions that include a combination of actions and positions, to generate captions that include other combinations of elements, and so on. At least one caption can be generated for each category specified in the input prompt 106 and a plurality of captions can be generated for each image in this way.

In other implementations, rather than using a static input prompt 106 for the second stage, an input prompt 106 can be constructed based upon the captioning dimensions approach discussed above.

In some implementations, if the image 105 has a corresponding existing caption, the model input 103 can include the existing caption, for example, as part of the input prompt 106 or otherwise. The caption 104 generated by the image captioning machine learning model 102 is expected to be different given the specificity constraints provided in the input prompt 106. In some implementations, the input prompt 106 can explicitly instruct the image captioning machine learning model 102 to generate a caption 104 that is different to the existing caption. Thus, where an image is associated with an existing caption, the processing to generate a caption for the image can be further based upon the existing image caption with the generated image caption being different to the existing image caption.

The generated captions can be stored with their corresponding images in a dataset for subsequent use in training an image generation machine learning model. In addition, or alternatively, the generated dataset can be transmitted to a model training system via any appropriate network connection. The generated captions can be used to augment an existing dataset of captioned images.

As the generated captions have mixed levels of specificity, this can help the image generation machine learning model to learn underlying concepts and how these concepts can be composed to form images, thus helping to improve the generalization capability and performance of the model. In addition, as the dataset includes captions that are likely to have a specificity that matches those provided by typical users of the image generation machine learning model, it is possible that any additional prompt re-writing phase is not required, thereby reducing the latency of the overall generation process.

The dataset can be used for training any type of image generation machine learning model. For example, the image generation machine learning model can comprise one or more diffusion neural networks (also known as denoising neural networks) such as DDIM (Denoising Diffusion Implicit Models) and DDPM (Denoising Diffusion Probabilistic Models). Further details with respect to these models are described in more detail below. In another example, the image generation machine learning model can be based upon a multi-modal LLM.

Whilst the above implementations describe an image captioning system, it will be appreciated that the described captioning techniques can also be applied to other modalities of data such as video and audio. Thus, a video captioning system comprising a video captioning machine learning model can also be configured to generate captions of mixed levels of specificity in a similar manner to that described above. The captioned video data can be used to train a video generation machine learning model. Likewise, an audio captioning system comprising an audio captioning machine learning model can also be configured to generate captions of mixed levels of specificity in a similar manner to that described above. The captioned audio data can be used to train an audio generation machine learning model. The above described techniques can also be applied to text data, for example to generate summaries of text documents such as emails or webpages.

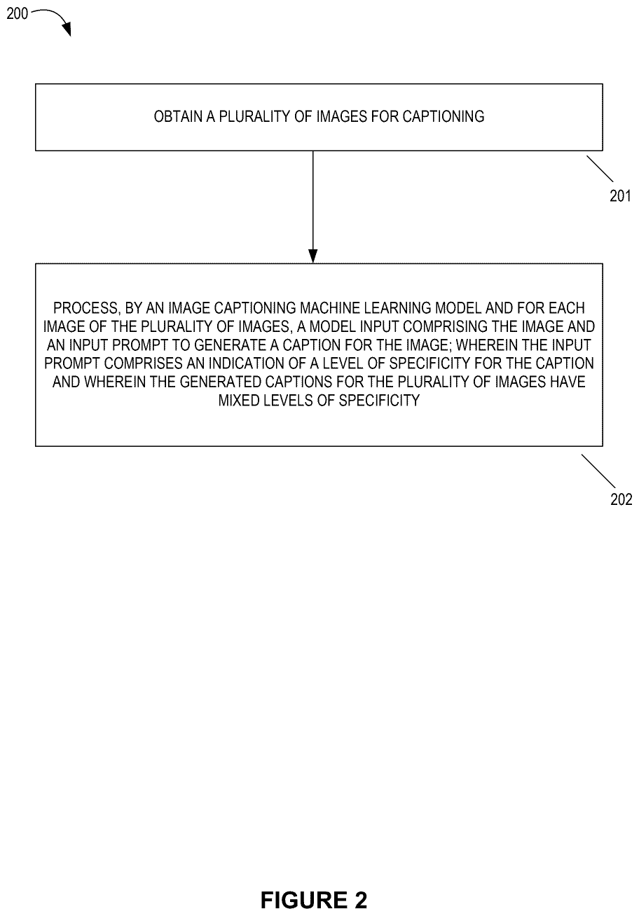

FIG. 2 is a flow diagram illustrating an example method 200 for building a training dataset for training an image generation machine learning model. The processing shown in FIG. 2 can be carried out using the image captioning system of FIG. 1.

At step 201, a plurality of images are obtained for captioning. As discussed above, the plurality of images can be part of an existing image dataset comprising pairs of images and captions. In some implementations, the images are obtained from the Internet and the corresponding “alt text” for the image is used as the caption. In some implementations, the existing image dataset only includes classification labels rather than natural language captions or the images can have no corresponding labels or captions.

At step 202, for each image of the plurality of images, an image captioning machine learning model processes a model input comprising the image and an input prompt to generate a caption for the image. In particular, the input prompt comprises an indication of a level of specificity for the caption and the generated captions for the plurality of images have mixed levels of specificity. The caption for the image describes the objects/entities that are depicted in the image in natural language.

As discussed above, the image captioning machine learning model can be any suitably trained image captioning machine learning model. For example, the image captioning machine learning model can be based upon a multi-modal large language model (LLM) that has been trained to provide descriptions of input images when prompted to do so. The input prompt can be text in natural language that instructs the image captioning machine learning model to generate a caption for the image and as noted above, includes an indication of a level of specificity for the caption. In some implementations, the input prompt comprises an indication of a plurality of levels of specificity and one or more captions are generated for each of the levels of specificity. Thus, a single image can be associated with multiple captions of multiple levels of specificity. Alternatively, only one caption is generated per image but the level of specificity in each input prompt varies across the plurality of images to provide a dataset with captions of mixed levels of specificity.

In some implementations, the model input comprises one or more variables. Thus, the model input can be dynamically generated by determining values for the one or more variables at run time.

As discussed above, in some implementations, the one or more variables includes the indication of a level of specificity for the caption. In some implementations, the indication of a level of specificity comprises a category selected from a set of categories defining a hierarchy. For example, the set of categories can be “low”, “medium”, and “high” and one category can be selected at random to indicate the level of specificity for the caption. The selection can be carried out by sampling from a uniform probability distribution or as discussed above, it is possible to generate captions at each level of specificity for each image. It will be appreciated that any suitable number of categories can be used to define the levels of specificity.

Alternatively, in some implementations, the indication of a level of specificity is based upon one or more captioning dimensions. As discussed above, a captioning dimension can control a particular aspect of a caption. For example, the one or more captioning dimensions can include one or more of the following: caption length, attribute specificity, quantification, location, scale, objectivity, in-image text, and image style as explained above. Each captioning dimension can be associated with a range of values and in order to determine the level of specificity, a value for one or more of the captioning dimensions can be determined.

For example, as discussed above, a probability distribution over the range of possible values for each captioning dimension can be obtained and a value selected for each captioning dimension based upon sampling from the corresponding probability distribution. The probability distribution can be a uniform probability distribution to enable a balanced selection, or the probability distribution can be any other suitable probability distribution. The range of values for each captioning dimension can be any suitable range as deemed appropriate by a person skilled in the art. The range of values can also include a “null” value, the selection of which would allow that captioning dimension to be omitted from the level of specificity. Alternatively, a first selection of which captioning dimensions to include can be carried out before determining the values of the selected captioning dimensions. Like the selection of values, the selection of which captioning dimensions to include can also be based upon sampling from a probability distribution, for example, each captioning dimension can have equal probability of being selected/not selected.

As discussed above, in some implementations, each captioning dimension can be associated with a set of sub-prompts and determining a value for a captioning dimension can comprise selecting a sub-prompt from the associated set of sub-prompts. Thus, when selecting a value for a captioning dimension, one of the sub-prompts from the set of sub-prompts can be selected. The indication of the level of specificity can be based upon a combination the selected sub-prompts for each captioning dimension. For example, the sub-prompts can be concatenated. The input prompt can comprise the combined sub-prompts (or more generally comprise the selected values for the captioning dimensions, e.g., the input prompt can comprise a template with slots to be filled by the selected values for the captioning dimensions). In this way, the indication of the level of specificity/the input prompt can be dynamically constructed. Thus, the one or more variables of the model input discussed above can include the one or more captioning dimensions.

In some implementations, a plurality of different input prompts can be constructed. In some implementations, the plurality of input prompts can be combined and provided together to the image captioning machine learning model to generate a plurality of corresponding captions in one processing step. In other implementations, each input prompt is processed separately by the image captioning machine learning model.

As discussed above, in another implementation, a two-stage process can be used to generate one or more captions for an image. In the first stage, the image captioning machine learning model identifies the entities depicted in the image and their relationships. Then in the second stage, the image captioning machine learning model generates one or more captions for the image based upon the identified entities and relationships. The one or more variables of the model input can therefore be based upon the identified entities and their relationships. In some implementations, the image captioning machine learning model can also identify one or more of: synonyms, attributes, positions/location, and/or actions being performed by the identified entity/entities. Thus, the one or more variables can be further based upon these elements. The indication of the level of specificity can comprise an indication of a mixture of a plurality of variables. For example, the indication of the level of specificity can indicate a combination of identified attributes and actions being performed or any other appropriate combination.

As discussed above, the two-stage process can be implemented using a chain of prompts. The first prompt can instruct the image captioning machine learning model to identify the entities and their relationships and any other desired elements. The output of the first stage can then be provided as part of the model input for the second stage. The prompt for the second stage (the input prompt) can instruct the image captioning machine learning model to generate a caption that includes a mixture of elements from the output of the first stage.

As discussed above, in some implementations, the input prompt in the second stage is static, that is, the same input prompt can be used for each image that is to be captioned. For example, the input prompt can instruct the model to generate captions for a plurality of different levels of specificities using the output of the first stage, e.g., to generate captions of low specificity, to generate captions of medium specificity, to generate captions of high specificity, to generate captions that include one or more attributes, to generate captions that include one or more actions, to generate captions that include a combination of actions and positions, to generate captions that include other combinations of elements, and so on. At least one caption can be generated for each category specified in the input prompt and a plurality of captions can be generated for each image in this way.

In other implementations, rather than using a static input prompt for the second stage, an input prompt can be constructed based upon the captioning dimensions approach discussed above.

In some implementations, where an image is associated with an existing caption, the processing to generate a caption for the image can be further based upon the existing image caption with the generated image caption being different to the existing image caption. For example, the model input can include the existing caption. This can be part of the input prompt or otherwise. The caption generated by the image captioning machine learning model is expected to be different given the specificity constraints provided in the input prompt. In some implementations, the input prompt can explicitly instruct the image captioning machine learning model to generate a caption that is different to the existing caption.

In some implementations, the processing can further include storing the generated captions with their corresponding images in a dataset for subsequent use in training an image generation machine learning model. In some implementations, the processing can further include training the image generation machine learning model using the generated captions. The image generation machine learning model is generally configured to generate an image according to a user prompt that describes the objects/entities that are to appear in the generated image. The image generation machine learning model can also be referred to as a text-to-image generation model.

In some implementations, the image captioning system and the system used to train the image generation machine learning model can be separate. As such, the generated caption dataset can be transmitted to the training system via any appropriate network connection.

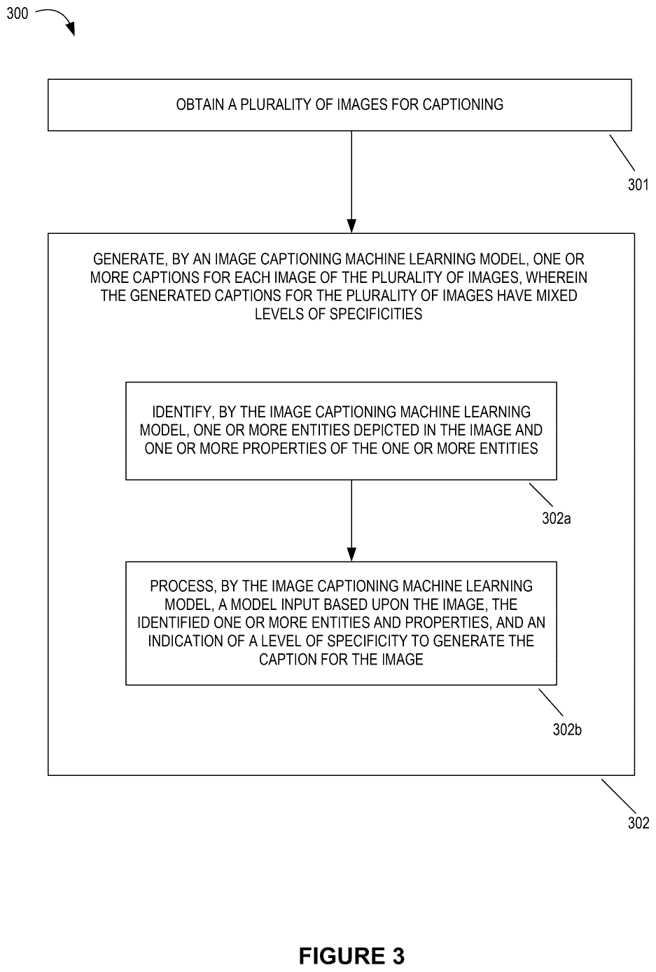

FIG. 3 is a flow diagram illustrating an example method 300 for building a training dataset for training an image generation machine learning model. In particular, the processing of FIG. 3 uses the two-stage approach described above. Thus, it will be appreciated that features described in the context of FIG. 2 can also be applied to the processing of FIG. 3. The processing shown in FIG. 3 can be carried out using the image captioning system of FIG. 1.

At step 301, a plurality of images can be obtained for captioning as per step 201 of FIG. 2.

At step 302, an image captioning machine learning model generates one or more captions for each image of the plurality of images. The generated captions for the plurality of images have mixed levels of specificities. Step 302 further comprises steps 302a and 302b.

At step 302a, the image captioning machine learning model identifies one or more entities depicted in the image and one or more properties of the one or more entities. As described above, in some implementations, the image captioning machine learning model identifies one or more of the following: synonyms for an entity, attributes of an entity, position of an entity, or actions performed by an entity. The image captioning machine learning model can also identify any relationships between the entities. As described above, the image captioning machine learning model can process the respective image and a first prompt instructing the image captioning machine learning model to carry out the relevant identifications. As discussed above, in some implementations, if the respective image is associated with an existing caption, the existing caption can also be provided as input at this stage.

At step 302b, the image captioning machine learning model processes a model input based upon the image, the identified one or more entities and properties, and an indication of a level of specificity to generate the caption for the image. The model input can also be based upon any other identified elements from the previous step 302a. In some implementations, at least one caption can be generated for each level of a plurality of levels of specificity and for various combinations of elements identified in step 302a.

As the two-stage approach involves running the image captioning machine learning model twice, the captioning process may be slower than a single stage approach. In cases where computational resources are limited, a one-stage approach (e.g., using captioning dimensions) may be preferred when the dataset is large, e.g., pre-training datasets, and the two-stage approach can be used for smaller datasets, e.g., fine-tuning datasets.

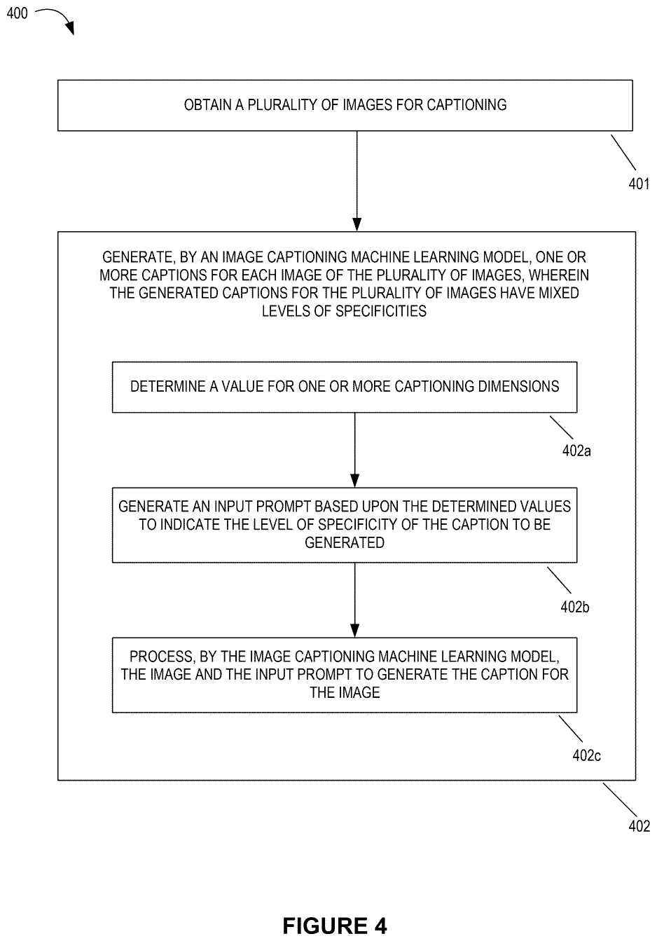

FIG. 4 is a flow diagram illustrating an example method 400 for building a training dataset for training an image generation machine learning model. In particular, the processing of FIG. 4 uses the captioning dimensions approach described above. Thus, it will be appreciated that features described in the context of FIG. 2 can also be applied to the processing of FIG. 4. The processing shown in FIG. 4 can be carried out using the image captioning system of FIG. 1.

At step 401, a plurality of images can be obtained for captioning as per step 201 of FIG. 2.

At step 402, an image captioning machine learning model generates one or more captions for each image of the plurality of images. The generated captions for the plurality of images have mixed levels of specificities. Step 402 further comprises steps 402a to 402c.

At step 402a, a value for one or more captioning dimensions is determined. As discussed above, a captioning dimension can control a particular aspect of a caption. For example, the one or more captioning dimensions can include one or more of the following: caption length, attribute specificity, quantification, location, scale, objectivity, in-image text, and image style as explained above. Each captioning dimension can be associated with a range of values from which a value for the one or more of the captioning dimensions can be determined. For example, a probability distribution over the range of possible values for each captioning dimension can be obtained and a value selected for each captioning dimension based upon sampling from the corresponding probability distribution.

At step 402b, an input prompt is generated based upon the determined values to provide an indication of the level of specificity of the caption to be generated. As discussed above, in some implementations, each captioning dimension can be associated with a set of sub-prompts and determining a value for a captioning dimension comprises selecting a sub-prompt from the associated set of sub-prompts. The indication of the level of specificity can be based upon a combination of the selected sub-prompts for each captioning dimension. For example, the sub-prompts can be concatenated. The input prompt can comprise the combined sub-prompts. In other implementations, the input prompt can comprise a template with slots to be filled by the determined values for the captioning dimensions.

At step 402c, the image captioning machine learning model processes the image and the input prompt to generate the caption for the image.

Whilst the above processing of FIGS. 2 to 4 describe image captioning, it will be appreciated that the described captioning techniques can also be applied to other modalities of data such as video and audio. In addition, the described processing can also be applied to text data, for example to generate summaries of text documents such as emails or webpages.

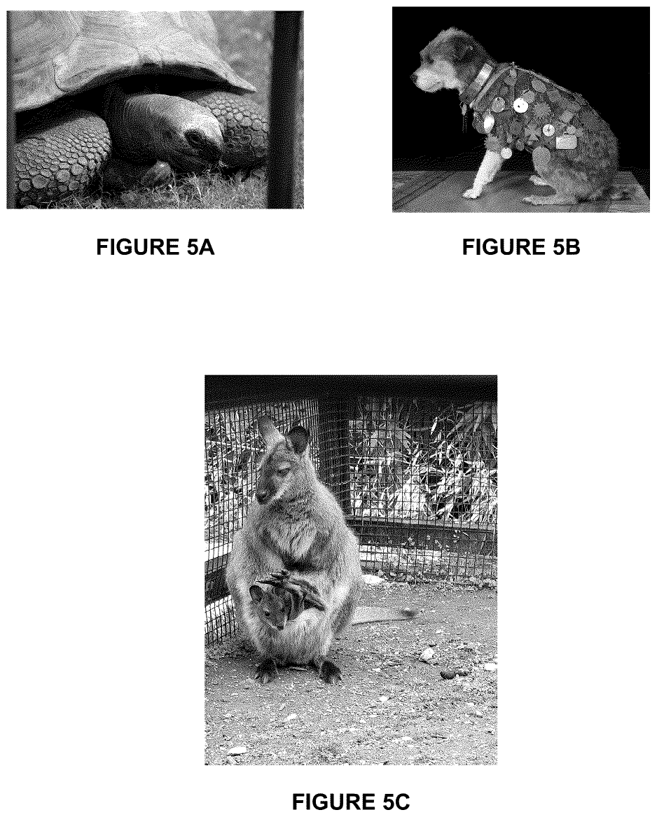

FIGS. 5A to 5C show example images for captioning. Each image was input to an image captioning model to generate a caption for the image. In some prior art methods, an image captioning model can be instructed with the input prompt of “Describe this image” without having any indication of a particular level of specificity. Using this non-specific input prompt, for the image of the tortoise in FIG. 5A, the image captioning model generates a caption of: “A close-up, eye-level shot reveals a giant Aldabra tortoise enjoying a meal of grass in a grassy enclosure. The foreground highlights the intricate texture of the tortoise's skin and shell, with a focus on its face and neck as it chews. A brown, vertical bar, possibly part of a fence, partially obscures the right side of the frame. The bright, sunny lighting casts subtle shadows and accentuates the details of the reptile and its surroundings. The scene evokes the tranquility of a natural habitat, despite the presence of the enclosure.”

By comparison, using the captioning dimensions technique described above, a first input prompt is generated as, “Describe the image. Prioritize clarity and direct observation over embellishment or interpretation. Keep the output to at most 5 words.” Using this first input prompt, for the same image in FIG. 5A, the image captioning model generates a caption of: “Tortoise eats grass behind fence.” As can be seen from this example, without providing a level of specificity, the image captioning model generates a detailed caption. The caption generated with the specificity constraint however provides a level of detail that is more in line with that provided by users to image generation systems.

In another example, a second input prompt is generated as, “Describe the image in detail. Keep the output to at most one paragraph. You should note visual characteristics such as composition, silhouette, color, and texture whenever they are unambiguously clear. If applicable, incorporate attributes that reflect sentiments or opinions conveyed by the image.” For this second input prompt, the image captioning model generates a caption of: “The image presents a close-up view of a large tortoise, likely an Aldabra giant tortoise, grazing on grass. The composition focuses on the animal's head and forelegs, with its shell rising prominently in the background and a portion of a fence post framing the right side. The tortoise's shell exhibits a warm, earthy brown tone and a rough, weathered texture, contrasting with the dark, leathery skin of its neck and legs. The color palette is primarily composed of browns, greens, and grays, creating a natural and somewhat subdued aesthetic. The overall impression is one of peaceful, slow-paced existence, underscored by the tortoise's focused grazing and the tranquil setting of green grass. The presence of the fence post, though, subtly suggests captivity and limits the sense of freedom associated with wildlife.” As can be seen from this example, the image captioning model generates a caption that is focused on the specified visual characteristics indicated in the prompt.

For the example image of FIG. 5B, providing an input prompt of “Describe this image” without any indication of the level of specificity to the image captioning model results in the following caption: “The image depicts a taxidermied dog, likely a terrier mix, adorned with a collection of antique dog license tags and other metal adornments. The dog is positioned in profile, sitting on a dark wooden surface against a black backdrop. The tags, of varying shapes and sizes, are attached to a leather harness covering the dog's back and are connected by chains, creating a visually striking display. The lighting emphasizes the texture of the dog's fur and the metallic sheen of the tags. The overall composition suggests a historical context, potentially highlighting the practice of dog licensing or commemorating a beloved pet. The careful preservation and presentation of the dog, along with the numerous tags, hint at a story of ownership and possibly the dog's role or significance to its owner.”

Using the captioning dimensions technique described above, an input prompt is generated as, “Describe the image in detail. If the image contains texts, do not forget to include their description. Please specify how many units are presented of the main entities in the picture.” Using this input prompt, for the example image of FIG. 5B, the image captioning model generates the following caption: “The image features one taxidermied, small, brindle-coated dog, possibly a terrier mix, in profile view, facing left against a black background. It wears a collection of at least 30 antique dog license tags and other metal ornaments attached to a tan leather harness secured around its body with rivets. This harness is connected to a wide, matching leather collar around the dog's neck.

The tags, varying in shape (round, oval, shield, and scalloped) and size, are mostly brass or silver-toned, each bearing engraved text and numbers. Some discernible inscriptions include:
“1882 ST. LOUIS” on a rectangular tag on the collar.
“HOTEL ADAMS NO. 45 WEBSTER” on a rounded, shield-shaped tag.
“ABTNA HOUSE DANVILLE, ILL 5 1” on a rectangular tag.
“MIDLAND BY 1047 BROOKLYN ANNEX BOX” on a square tag.
“BUFFALO NY TRANSFER HOUSE 13 NEW HAVEN” on a rectangular tag.
“VIENNA HOTEL REGISTERED 317” on a small oval tag.
“U.S. MAIL BAG & LOCK REPAIR SHOP APPL 13 92 WASHINGTON DC” on a round tag.

Various numerical inscriptions like “38” and “56” on different tags, suggesting license numbers. The tags hang from the harness by small chains and metal loops. The dog sits on a dark, wood-grained surface, possibly a table. The lighting illuminates the dog and its metal decorations, contrasting sharply with the black background and revealing the textures of fur and metal. The dog's expression is fixed in a neutral, slightly inquisitive pose.”

As can be seen from this example, the image captioning model ignores the text on the tags when there is no specificity constraint in the input prompt. As such, in prior art methods, the image captioning model may choose to ignore some text present in an image which in turn could reduce the performance of an image generation model trained on such data.

In another example, using the captioning dimensions technique described above, a second input prompt is generated as, “Describe the image. Keep the output to at most 5 words. Do not forget to mention the type/style of the image.” Using this second input prompt, for the example image of FIG. 5B, the image captioning model generates the following caption: “Taxidermied dog with tags.” Again, in this example, a caption is generated that is more in line with the level of detail provided by a user to an image generation system.

For the example image of FIG. 5C, providing an input prompt of “Describe this image” without any indication of the level of specificity to the image captioning model results in the following caption: “Eye-level view of a wallaby within an enclosure, with a joey peeking from its pouch. The photo seems taken at a zoo or animal park.

The adult wallaby is centered in the frame, standing on dirt and sparse grass. A chain-link fence with bamboo partially obscures the background. The wallaby's fur is brownish-gray, and it has large, upright ears and dark eyes. It's holding its pouch open, revealing a small joey inside. The joey's face and forepaws are visible, its fur appearing slightly darker than its mother's. The enclosure appears relatively simple, with a dirt floor scattered with small rocks, patches of grass, and some wallaby droppings. The chain-link fence suggests a contained environment, and the bamboo provides a hint of greenery and a more natural element within the enclosure.

The lighting in the photo is even and natural, likely an outdoor setting on an overcast day, casting no significant shadows and allowing for clear visibility of both the adult wallaby and the joey. The overall impression of the image is one of observation, capturing a moment of the wallaby's maternal behavior in a zoo or wildlife park setting.”

Using the captioning dimensions technique described above, an input prompt is generated as: “Describe this image. Incorporate Specificity: use attributes, specific names or brands or notable features when present. Keep the output to at most 10 words.” Using this input prompt, for the example image of FIG. 5C, the image captioning model generates the following caption: “A wallaby and its joey in a fenced enclosure with bamboo.”

In another example, using the captioning dimensions technique described above, a second input prompt is generated as: “Describe this image. Incorporate Genericities: that is, describe image elements using generic nouns and attributes. Keep the output to at most 10 words.” Using this second input prompt, for the example image of FIG. 5C, the image captioning model generates the following caption: “Animal with young in fenced outdoor area.”

As can be seen in this example, using an unconstrained prompt, the image captioning model uses the identified species of animal, a wallaby and the specific name for its young, joey, in the generated caption. When the input prompt specifies incorporating genericities, the image captioning model generates a caption referring simply to an animal and its young. With different captions that include both generic and specific terms for entities in the same image, it is likely to be easier for an image generation model to learn what a wallaby is and that a wallaby is a type of animal and how it differs from other animals. Without indicating this type of specificity, the image captioning model would likely only refer to the animal as a wallaby and it may be that an image dataset captioned in this way has no explicit link between the concepts of wallaby and animal. As such, this can make it harder for the image generation model to learn to generalize.

Generation of data (e.g., images, video, audio) using diffusion neural networks (also known as denoising neural networks) will now be described in more detail. Examples of diffusion models include DDIM (Denoising Diffusion Implicit Models) and DDPM (Denoising Diffusion Probabilistic Models). In general, diffusion models generate data by using a noise removal process which is also known as a reverse diffusion process. To perform a reverse diffusion process, the system can utilize a conditioning input, for example, a user prompt or modified user prompt as discussed above.

The generation system can initialize a representation of a new data item by sampling noise values from a noise distribution. The system can then update the representation of the new data item at each of a plurality of reverse diffusion steps. As part of the updating, at each reverse diffusion step, the system processes a denoising input for the reverse diffusion step that includes the representation of the new data item using the diffusion neural network conditioned on the conditioning input to generate a denoising output that defines an estimate of a noise component of the representation of the new data item.

Optionally, the system can use classifier-free guidance at each reverse diffusion step. When using classifier-free guidance, the system processes another denoising input for the reverse diffusion step that includes the representation of the new data item using the denoising neural network but not conditioned on the conditioning input to generate another denoising output. The system then combines the conditional and unconditional denoising outputs in accordance with a guidance weight for the reverse diffusion step to generate a final denoising output.

At each reverse diffusion step, the system then updates the representation of the new data item using the denoising output. For example, the system can determine an estimate of the data item using the denoising output and then apply an appropriate diffusion sampler, e.g., the DDPM sampler, the DDIM sampler or another appropriate sampler, to the estimate to update the current representation. At the last reverse diffusion step, the system can use the estimate as the updated representation.

After updating the representation of the new data item at each of the plurality of reverse diffusion steps, the system generates the new data item from the representation of the new data item. Each denoising output can define an estimate of a noise component of the corresponding representation of the corresponding data item. The denoising output can define this estimate in any of a variety of ways.

In some implementations, the denoising output is an estimate of the noise component of the current representation, i.e., the noise that needs to be combined with, e.g., added to or subtracted to, a final representation to generate the current representation.

In some other implementations, the denoising output is an estimate of the final representation given the current representation, i.e., an estimate of the representation that would result from removing the noise component of the current representation.

In some other implementations, the denoising output defines a predicted residual between the true noise component of the current representation and an analytic estimate of the noise component, i.e., an estimate that has been computed analytically from the current representation.

In some other implementations, the denoising output is a v-parametrization of the estimate of the noise component.

In any of the above examples, the representations of the data item received as input by the diffusion neural network and updated using the diffusion neural network can either be representations in the output space, e.g., so that the values in the representation are values of image pixels, or an output data item in a latent space, e.g., so that the values in the representation are values in a latent representation of an image in the output space.

When the representations are in a latent space, the system can generate the data item in output space by processing the final representation in the latent space using a decoder neural network, e.g., one that has been pre-trained in an auto-encoder framework with an encoder neural network. During training, the system can use an encoder neural network, e.g., one that has been pre-trained jointly with the decoder in the auto-encoder framework, to encode target data items in the output space to generate target representations for the diffusion neural network in the latent space.

The diffusion neural network can be any appropriate diffusion neural network that is configured to receive an input that includes a current (noisy) representation of a data item and a conditioning input and to generate a denoising output.

In some implementations, the diffusion neural network performs a diffusion process in output space, e.g., pixel space when the data items are images. In this example, when the data items are images, the data items (“representations”) operated on and generated by the diffusion neural network have values for each pixel that specify color values, e.g., RGB values or another color encoding scheme.

Examples of such diffusion neural networks include Imagen, further details of which can be found in S. Chitwan, et al., “Photorealistic text-to-image diffusion models with deep language understanding.” Advances in neural information processing systems 35 (2022): 36479-36494 which is hereby incorporated by reference in its entirety.

In some other implementations, the diffusion neural network performs a diffusion process in latent space, e.g., in a latent space that is lower-dimensional than the output space. That is, the data items (“representations”) operated on by the diffusion neural network are latent representations and the values in the representations are learned, latent values, e.g., rather than color values when the data items are images.

An example of such a latent diffusion model is Imagen 3, further details of which can be found in Baldridge, Jason, et al., “Imagen 3” arXiv preprint arXiv: 2408.07009 (2024) which is hereby incorporated by reference in its entirety. A further example of a latent diffusion model can also be found in R. Rombach, et al., “High-Resolution Image Synthesis with Latent Diffusion Models,” arXiv: 2112.10752 (2021), which is hereby incorporated by reference in its entirety.

In these implementations, during training, the diffusion neural network can be associated with an encoder to encode training data items into the latent space and, after training and to generate new output data items, a decoder neural network that receives an input that includes a latent representation of a data item and decodes the latent representation to reconstruct the data item.

In general, diffusion neural networks can be trained using a training dataset of the type of data to be generated, e.g., an image dataset, a video dataset, an audio dataset etc. Image and video data can be captured by an image sensor of a digital camera, LIDAR, infra-red camera or any other camera type. Audio data can be captured from an audio transducer such as a microphone.

The diffusion neural network can be trained over a plurality of training iterations. In each training iteration, one or more training data items can be sampled from the training dataset. A timestep can be sampled, e.g., from a uniform probability distribution, for each of the one or more training data items. Noise can be sampled, e.g., from a Gaussian distribution, to be used in a forward diffusion process that adds noise to the training data item up to the sampled timestep. The diffusion neural network attempts to predict the added noise based upon the noisy image and the timestep. The parameters of the diffusion neural network can be updated using an objective function based upon a comparison between the predicted noise and the sampled noise.

Data can also be generated using other techniques including: techniques based upon consistency models, further details of which can be found in Heek, Jonathan, Emiel Hoogeboom, and Tim Salimans. “Multistep consistency models.” arXiv preprint arXiv: 2403.06807 (2024) which is hereby incorporated by reference in its entirety; techniques based upon rectified flow, further details of which can be found in Liu, Xingchao, Chengyue Gong, and Qiang Liu. “Flow straight and fast: Learning to generate and transfer data with rectified flow.” arXiv preprint arXiv: 2209.03003 (2022) which is hereby incorporated by reference in its entirety; and techniques based upon autoregressive image generation, further details of which can be found in Yu, Jiahui, et al., “Scaling autoregressive models for content-rich text-to-image generation.” arXiv preprint arXiv: 2206.10789 (2022) which is hereby incorporated by reference in its entirety.

Further details regarding LLMs will now be described. An LLM can be an auto-regressive neural network that generates each token in an output sequence conditioned on the preceding tokens in the output sequence and at least some of the tokens in an input sequence.

For example, the LLM can be configured to process an input sequence of tokens from a vocabulary of tokens to generate an output sequence of tokens from the vocabulary.

More generally, an LLM generative machine learning model can be any appropriate neural network that receives an input sequence made up of tokens selected from a vocabulary and auto-regressively generates an output sequence made up of tokens from the vocabulary. For example, the generative machine learning model can be a Transformer-based neural network or a recurrent neural network-based neural network.

In some situations, the generative machine learning model can be referred to as an auto-regressive neural network when the neural network used to implement the neural network auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the generative machine learning model can process the current input sequence to generate a score distribution (e.g., a probability distribution) that assigns a respective score, e.g., a respective probability, to each token in the vocabulary of tokens. The generative machine learning model can then select, as the particular token, a token from the vocabulary using the score distribution. For example, the generative machine learning model can greedily select the highest-scoring token or can sample, e.g., using nucleus sampling or another sampling technique, a token from the distribution.

As a particular example, the generative machine learning model can be an auto-regressive Transformer-based neural network that includes (i) a plurality of attention blocks, at least some of which apply a self-attention operation and (ii) an output subnetwork that processes an output of the last attention block to generate the score distribution.

The generative machine learning model can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al., Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al., Language models are few-shot learners. arXiv preprint arXiv: 2005.14165, 2020. All of which are hereby incorporated by reference in their entirety.

The generative machine learning model can undergo a first phase of pre-training followed by a second phase of fine-tuning. In general, a generative machine learning model such as an LLM can be pre-trained on large amounts of data including data from, but not limited to, webpages, electronic books, software code, electronic news articles, and machine translation data. The generative machine learning model can be pre-trained using unsupervised or self-supervised learning. For example, the generative machine learning model can be pre-trained on a next token prediction task and/or a masked token prediction task. Pre-training on large quantities of diverse data can provide the generative machine learning model with remarkable natural language reasoning capabilities.

Following pre-training, the generative machine learning model can undergo fine-tuning to improve the model's ability to respond to user prompts and queries. Two example types of fine-tuning techniques are supervised fine-tuning (SFT) and reinforcement learning with human feedback (RLHF).

In SFT, a high-quality dataset including examples of input prompts and corresponding responses can be used. This data is typically generated by human annotators. The generative machine learning model can be trained using supervised learning to generate the corresponding responses from the input prompt. SFT requires a much smaller amount of data that used in pre-training.

In RLHF, a reward model can be trained from human preference data regarding different outputs generated from the same input prompt. That is, given an input prompt, different outputs are generated using different models. The models can be a copy of the generative machine learning model with different parameters obtained through checkpointing during pre-training or the models could be entirely unrelated. The input prompt and the different outputs are shown to human assessors and the human assessors are asked to rank the outputs in order of preference with respect to the input prompt. This can be repeated with many different input prompts to generate a dataset of preference data. A reward model can be trained on this preference data to provide a scalar preference value (a “reward” value) for a particular input prompt and generated output pair. The reward model can be based on the generative machine learning model with an additional head for generating the scalar value for example.

The generative machine learning model undergoing training can then be fine-tuned using reinforcement learning based upon the reward values provided by the trained reward model. That is, for a given training prompt, the generative machine learning model generates an output which can be evaluated using the reward model. The parameters of the generative machine learning model can be adjusted using a reinforcement learning update rule based upon the reward value provided by the reward model. In some implementations, a reinforcement learning update rule based upon the Proximal Policy Optimization (PPO) algorithm is used with the generative machine learning model acting as the “policy”.

Through such training, it is possible that a generative machine learning model can respond to user queries and instructions in a zero-shot manner, for example, by including appropriate instructions and examples in the prompt provided to the generative machine learning model without the need for further extensive fine-tuning. For example, an LLM-based generative machine learning model can be prompted to caption an input image or other data item.

It will be appreciated that the above is not limited to processing text tokens only. In some implementations, an LLM can process and generate tokens of other modalities including image tokens, audio tokens and video tokens. These models are sometimes also referred to as Visual Language Models (VLMs) or multi-modal language models or some variation of such terms. An example of these multi-modal models includes the Gemini family of models, further details of which can be found in Google Gemini Team, “Gemini: a family of highly capable multimodal models.” arXiv preprint arXiv: 2312.11805 (2023) which is hereby incorporated by reference in its entirety. A further example is PaliGemma 2, further details of which can be found in Steiner, Andreas, et al., “PaliGemma 2: A Family of Versatile VLMs for Transfer.” arXiv preprint arXiv: 2412.03555 (2024) which is hereby incorporated by reference it is entirety.

It will be appreciated that the above also applies for any autoregressive neural network that is used in the data generation process. An example of an autoregressive neural network for audio generation is AudioLM, further details of which can found in Z. Borsos, et al., “Audiolm: a language modeling approach to audio generation.” IEEE/ACM transactions on audio, speech, and language processing 31 (2023): 2523-2533 which is hereby incorporated by reference in its entirety.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

As used herein, the term data processing apparatus includes any suitable computing device or hardware for use in performing the methods described in this specification. The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The essential elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. In some cases, multitasking and parallel processing may be advantageous.

What is claimed is:

1. A method performed by one or more data processing apparatus, the method comprising:
obtaining a plurality of images for captioning;
processing, by an image captioning machine learning model and for each image of the plurality of images, a model input comprising the image and an input prompt to generate a caption for the image;
wherein the input prompt comprises an indication of a level of specificity for the caption; and
wherein the generated captions for the plurality of images have mixed levels of specificity.

2. The method of claim 1, wherein the model input comprises one or more variables.

3. The method of claim 2, wherein the one or more variables includes the indication of a level of specificity for the caption.

4. The method of claim 1, wherein the indication of a level of specificity comprises a category selected from a set of categories defining a hierarchy.

5. The method of claim 1, wherein the indication of a level of specificity is based upon one or more captioning dimensions.

6. The method of claim 5, wherein the one or more captioning dimensions comprises one or more of the following: caption length, attribute specificity, quantification, location, scale, objectivity, in-image text, and image style.

7. The method of claim 6, wherein the method further comprises:
determining a value for one or more of the captioning dimensions.

8. The method of claim 7, wherein determining a value for one or more of the captioning dimensions comprises:
obtaining a probability distribution over the range of possible values for each captioning dimension of the one or more captioning dimensions; and
selecting a value for each captioning dimension based upon sampling from the corresponding probability distribution.

9. The method of claim 7, wherein each captioning dimension is associated with a set of sub-prompts and wherein determining a value for a captioning dimension comprises selecting a sub-prompt from the associated set of sub-prompts.

10. The method of claim 9, wherein the indication of a level of specificity is based upon a combination of the selected sub-prompts.

11. The method of claim 2, wherein the method further comprises:
identifying, by the image captioning machine learning model, the entities depicted in the image and their relationships; and
wherein the one or more variables are based upon the identified entities and their relationships.

12. The method of claim 11, wherein the one or more variables are further based upon one or more of the following: synonyms for an entity, attributes of an entity, position of an entity, or actions being performed by an entity.

13. The method of claim 12, wherein the indication of a level of specificity comprises an indication of a mixture of a plurality of variables.

14. The method of claim 1, wherein an image of the plurality of images is associated with an existing image caption;
wherein the processing to generate a caption for the image is further based upon the existing image caption; and
wherein the generated caption is different to the existing image caption.

15. The method of claim 1, wherein the image captioning machine learning model is based upon a multi-modal large language model (LLM) type generative machine learning model.

16. The method of claim 1, wherein the input prompt comprises an indication of a plurality of levels of specificity; and wherein one or more captions are generated for each of the levels of specificity of the plurality of levels of specificity.

17. The method of claim 1, wherein the method further comprises:
training an image generation machine learning model using the generated captions.

18. A system comprising:
one or more data processing apparatus; and
a memory storing instructions that when executed by the one or more data processing apparatus cause the one or more data processing apparatus to carry out a method comprising:
obtaining a plurality of images for captioning;
generating, by an image captioning machine learning model, one or more captions for each image of the plurality of images, wherein the generated captions for the plurality of images have mixed levels of specificities;
wherein generating a caption for an image comprises:
identifying, by the image captioning machine learning model, one or more entities depicted in the image and one or more properties of the one or more entities; and
processing, by the image captioning machine learning model, a model input based upon the image, the identified one or more entities and properties, and an indication of a level of specificity to generate the caption for the image.

19. A non-transitory computer-readable storage medium comprising instructions that when executed by one or more data processing apparatus cause the one or more data processing apparatus to carry out a method comprising:
obtaining a plurality of images for captioning;
generating, by an image captioning machine learning model, one or more captions for each image of the plurality of images, wherein the generated captions for the plurality of images have mixed levels of specificities;
wherein generating a caption for an image comprises:
determining a value for one or more captioning dimensions;
generating an input prompt based upon the determined values to indicate the level of specificity of the caption to be generated; and
processing, by the image captioning machine learning model, the image and the input prompt to generate the caption for the image.

20. The non-transitory computer-readable storage medium of claim 19, wherein each captioning dimension is associated with a set of sub-prompts and wherein determining a value for a captioning dimension comprises selecting a sub-prompt from the associated set of sub-prompts.
